(19) United States
(12) Patent Application Publication
(10) Pub. No.: US 2007/0094913 A1
(43) Pub. Date: May 3, 2007

(54) Releaseable/slideable line lock

(75) Inventor: Donald J. Link, Shakopee, MN (US)

Correspondence Address: ALTERA LAW GROUP, LLC, 6500 CITY WEST PARKWAY, SUITE 100, MINNEAPOLIS, MN, 55344-7704, US

(73) Assignee: Skirts Plus Corporation

(21) Appl. No.: 11/591,628

(22) Filed: Nov. 1, 2006

Related U.S. Application Data
(60) Provisional application No. 60/732,070, filed on Nov. 1, 2005.

(51) Int. Cl. A01K 85/00; E05B 15/00; E05B 63/00

(52) U.S. Cl. 43/42.08; 70/1

(57) ABSTRACT

The present disclosure relates to a locking device for use in releasably securing sliding elements to a line or filament and for cushioning the shock of impact of the sliding element against a line stop. The sliding element has a stop element located in a passage which runs the length thereof. The stop element is then twisted to engage the filament and is prevented from untwising (counter-rotating) by locking means. Cushioning of impact with a line stop (knot, for example) is accomplished by the elastomeric bumpers which extend from the stop element out of the sliding element.

### CROSS-REFERENCE TO RELATED APPLICATIONS

The present application claims the benefit of U.S. Provisional Application Ser. No. 60/732070 filed on 01 Nov. 2005, the complete subject matter of each of which is hereby incorporated herein by reference in its entirety.

### STATEMENT REGARDING FEDERALLY SPONSORED RESEARCH OR DEVELOPMENT

Not Applicable

### TECHNICAL FIELD

The present invention relates to a locking device for use in releasably securing elements to a line or filament. The preferred embodiment is intended for use as a releasable/slideable lock for a sinker used on a fishing line.

### BACKGROUND OF THE INVENTION

Attaching elements to lines or filaments, such as a sinker on a fishing line is well known in the art. Such an attachment means can be as simple as a loop and a knot in the filament. The problem with such systems is that 1) they cannot be removed without breaking the filament; and 2) the position of the element cannot be moved relative to the filament without great difficulty.

Improved devices also exist. One example is to incorporate a corkscrew like feature into a sinker and screw the sinker into some other element on the filament. Such a device is made by Bullet Weights™ and sold under part number 33-423-556 sold by Bass Pro, Inc. (www.basspro.com). This solution does not really address either of the above problems.

Another solution using a “peg”, being as simple as a toothpick or a rubber strip (such as made by Bullet Weights™ T-stops part number 33-43-656-01), sold by Bass Pro, Inc. These pegs are slid into the axial opening in the sinker along with the filament. The pegs are tapered so the filament becomes entrained between the opening and the peg. The pegs can be removed (perhaps by destruction thereof) and the sinker can be moved along the filament until re-pegged. This solution addresses problem no. 2 above but is no help in allowing the complete removal of the sinker from the line without cutting the line.

There exists a need, in general, and specifically with elements attachable to fishing lines, to allow for releaseability and moveability of the element on the filament.

There also exists a need to prevent breakage or damage to a line when a slideable element rapidly contacts a stop on the line (such as a knot).

### SUMMARY OF THE INVENTION

The following summary is provided to assist the reader in reading this entire document. The scope of invention is defined by the claims, not this summary.

There are many aspects of the invention. For example, there is disclosed a releasable slideable lock for securing the position of an element slideable on a filament line having a slideable element have two ends and a passage therethrough for receiving said line, a stop element point located proximate said passage, the element extending between send ends and having a sleeve connecting same, said stop element being capable of being twisted to cause engagement of sleeve with the line; an anti-rotation element configured to engage said stop and slideable elements to prevent counter rotation of the stop element relative to said slideable element after making twisting engagement with the line; so that, when said stop element is twisted to engage the line and prevented from untwisting by the anti rotation element, the slideable element is thereby prevented from sliding along the line until the anti-rotation element is disengaged.

There is also disclosed a method of releasably fixing the position of a slideable element having a passage therethrough, on a line comprising the steps of: elongating an elastomeric twistable sleeve; inserting the sleeve into the passage while elongated, sliding the line through the sleeve within said slideable element; positioning the slideable element where desired along the line, twisting the sleeve sufficiently to engage the line and prevent slippage.

This is also disclosed a method of manufacturing the locking device.

There is also disclosed a shock protector for a slideable for an element having ends and a passage therebetween and being slideable on a line having a fixed stop, having a shock absorbing element extending from said ends and connected through said passage and having resilient portions which extend beyond said ends; so that when said slideable element encounters said fixed stop, the contact is cushioned by said resilient portions.

There are other aspects of the invention which can be found in the complete description and drawings below.

### BRIEF DESCRIPTION OF THE DRAWINGS

FIG. 1 is a perspective view of a tapered body sinker according to one embodiment of the invention.

FIG. 2 is a securing feature according to one embodiment of the invention.

FIG. 3 is a securing feature according to one embodiment of the invention.

FIG. 4 is a securing feature according to one embodiment of the invention.

FIG. 5 is a securing feature according to one embodiment of the invention.

FIG. 6 is a perspective view of a tapered body sinker according to another embodiment of the invention.

FIG. 7 is a partial cutaway view of a stop element according to one embodiment of the invention.

FIG. 8 is a cross section of the sleeve feature according to one embodiment of the invention.

FIG. 9 is a cross section of the sleeve feature according to one embodiment of the invention.

FIG. 10 is a cross section of the sleeve feature according to one embodiment of the invention.

FIG. 11 is a partial cutaway view of a tapered body sinker and stop element and securing feature according to one embodiment of the invention.

FIG. 12 is a partial cutaway view of a tapered body sinker and stop element and securing feature according to one embodiment of the invention.

FIG. 13 is a partial cutaway view of a tapered body sinker and stop element and securing feature according to one embodiment of the invention.

### DETAILED DESCRIPTION OF THE PREFERRED EMBODIMENTS

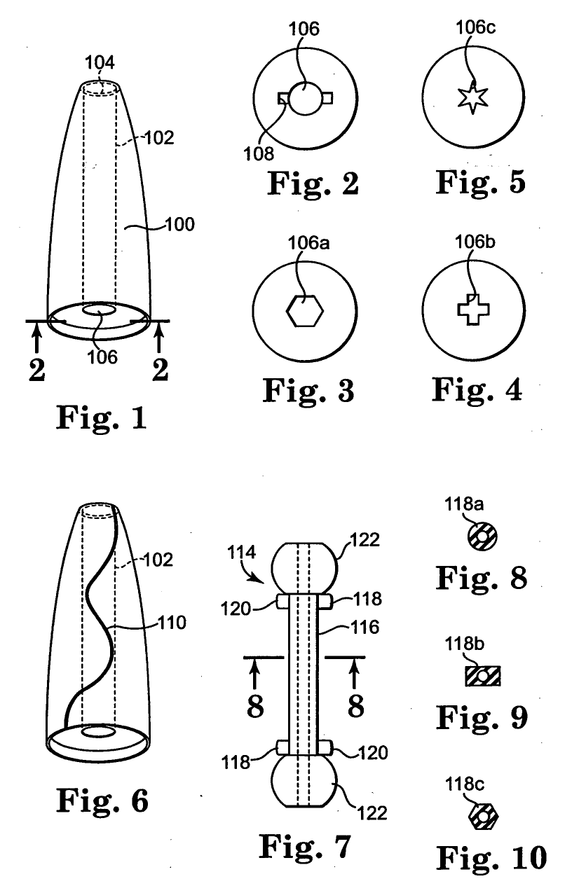

FIG. 1 shows an element 100, which in this case is a tapered body sinker of heavy metal. The element could be a bobber, a weight holder (a/k/a drop shot rig) or an element unrelated to the fishing arts, such as a connector or flag on a line or filament. Note that line or filament is meant in its most generic sense, such as from a micro-thin optical fiber to a large diameter steel cable. This invention is not limited to the type of line. The term filament is only used for convenience and is not a limitation.

Through the core of the element is a passage 102 with openings 104 and 106 at its ends. The passage is shown as linear/straight, but can be serpentine, spiral or other path, though straight is preferred.

Openings 104/106 can be circular, but the preferred structure is a non-round shape as it aids in its other function as a stop, as will be explained later. Therefore, other shapes are shown in FIGS. 2-5, such as round with ears (points of engagement) 108, star shaped 106c, hex or octagon 106a and cross/star/Phillips 106b. Many other shapes are acceptable and are incorporated herewith. Such shapes have some element which would prevent the rotation of a stop element (discussed below). Thus the importance of the shape selection is its ability to mate with the stop element and prevent counter-rotation.

FIG. 6 illustrates another feature of the invention. In addition to the passage 102 in the body 100, a second cut into the body can be made from the outside. This access cut or slit 110, permits the filament (any kind of line) to reach the passage 102 without the need to thread the filament through the passage end to end. This would require either cutting the line or having a free end to the line, something which is often impossible.

Instead, the access cut, whether straight (not shown) or other pattern, provides a way to slide the line into the passage without having a free end. Thus the cut must be at least large enough to accommodate the filament (directly or under compression) and small enough that a portion of the stop element 114 can be inserted therein, preferably under compression or distention by stretching (elongating).

The use of a serpentine cut 110 makes it more difficult for the line to slide free on its own without manual assistance. A notched cut (having a jog offset portion) 112 in FIG. 12 is an alternative. It has a sharp right angle which accomplishes the same effect as the serpentine cut, but is even more reliable in preventing separation of the element; however, it is much more difficult to insert the line therein.

To make the invention have the slideable feature, a stop (or stopper) element 114 is inserted into the opening 102 and it is friction created by twisting of the stop element which locks the filament to the element 100, such as a sinker or bobber, in the fishing arts. In this embodiment, the stop element is shown as a sleeve that separates the line 140 from the inner surface of the passageway 102.

Stop element 114, has an elongated body/twistable sleeve 116, preferably made of an elastomeric material. The body is preferably sized to extend to and preferably beyond the length of passage 102 so that it extends beyond the opening 104 and 106.

At the end of the body are preferably anti-rotation elements (ears) 118 on either or both ends. These anti-rotation elements/features are shown with ears 120 which correspond to notches/recesses 108 in or associated with (i.e. in some way mechanically linked with) element 100 in FIG. 2. It can be appreciated, that when the ears and notches mate, the body is secured against rotation on both ends.

It is possible to create this securing feature with other shapes as shown both in FIGS. 2-5 and 8-10 (oval, rectangular, hex or non circular cross section, etc), so long as an interlocking engagement is achieved to prevent relative rotation. Entirely different anti-rotation elements or means are contemplated within the scope of this term. It is only required that the counter rotation be prevented when the element is twisted to the desired degree.

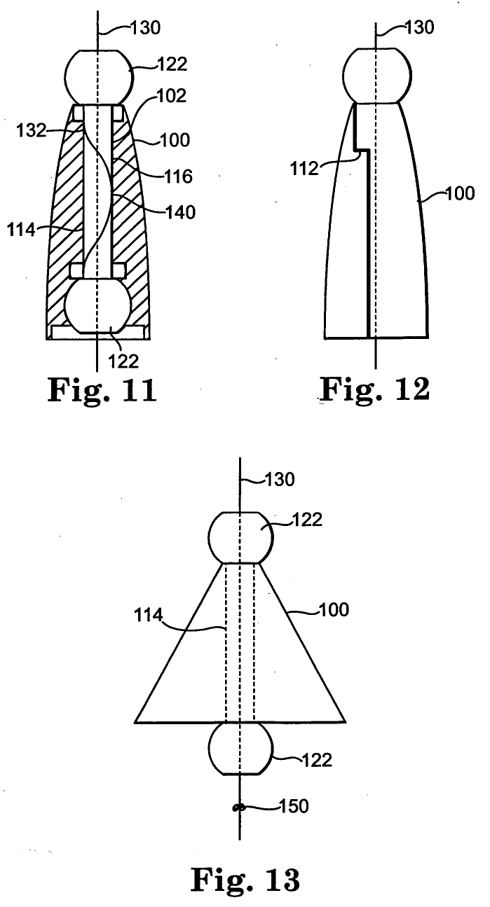

FIG. 11 illustrates the concept of how the stop 114 engages the filament 130 (shown in broken lines as it passes through the element 100 and passage 102).

The stop is first inserted into the element 100 in one of two ways. Either by forcing it through one opening 104/106 to the other, or by forcing it through the cut 110 (not shown in FIG. 11). It may be preferable to stretch the stop lengthwise to make it thinner for purposes of getting into the cut 110 since it will generally be preferred to make it wider than the cut, so that it cannot fall out.

With the stop in place, and the filament threaded therethrough, it is now possible to lock the element (such as a bobber, sinker or some other element) to the line/filament.

In the preferred embodiment, the user twists either (bulbous) end 122 of the stop 114. The shape of the end 122 should be large enough so as not to be drawn into the passage 104. It may help to pull end 122 upwardly away from the element 100 for ease of twisting. This will cause the body 116 to engage the filament 130 and prevent it from slipping. This twisting is schematically suggested by line 140 in FIG. 11 (140 is not a serpentine cut).

It is possible that the stop could become untwisted; thereby allowing the filament to be released, but the addition of engagement elements will prevent this.

The preferred engagement element are the anti-rotation elements 118 which engage recesses 108 (FIG. 2) but as shown in FIGS. 2-5 and 8-10, there are a multiplicity of ways to prevent counter rotation of the twisted body 116. Fundamentally, it is necessary to engage both ends of the stop element with the main element 100 to prevent counter rotation. Shaping the elements 118 to mate with like recesses 108 (of any shape) will accomplish this.

Note that it would be possible to fix one end 122 and twist the other. Fixing could be accomplished by gluing or swedging (or like means for fixing) the end against counter-rotation. It would be possible to eliminate one of the bulbus ends 122 by gluing or otherwise fixing the body 116 to the element 100 near one end (it must be however free to twist at least a portion of the body to insure engagement with the line).

FIG. 12 shows a cut 112 in element 100 which is not serpentine but has at least one shoulder (though it may be curved and not at right angles as shown) to prevent the stop body from sliding out of the element 100.

FIG. 13 illustrates another advantage of the present invention. In this configuration the element 100 has a stop and the ends of the stop 130 are shown. The line 130 has a knot 150 (or other fixed stop on the line) and when the stop 114 is in its released/relaxed position, the element is free to slide along the line 130. This might be a common occurrence in any use of this device.

A common problem with heavy objects which are slideable is that they encounter fixed stops and with the stop the impact can damage the line. In the case known, the impact of a heavy sinker could snap the line or gradually weaken it. Thus it would be desireable to prevent hard impacts. The ends 122 of the stop element provide the additional advantage that they cushion the impact of a slideable object against the shock of a fixed stop on the line.

It is appreciated that this shock absorbing/protecting feature can be provided to any slideable element without the need for the stop/locking engagement feature of twisting the body 114 around the line 130. In such case, the anti-rotation features of this device are not required. Rather, only an elastomeric or other cushioning material extending from at least one end of the slideable element 100.

It will be appreciated that this detailed description of the invention and preferred embodiments is not all encompassing. To cover every possible variation would make this text impossibly long. Instead, the inventive concepts and some preferred embodiments were explained in detail but deviation from the preferred embodiments to other structures within the scope of the inventive concepts is to be considered part of this invention.

1. A releasable slideable lock for securing the position of an element slideable on a filament line comprising:
(a) a slideable element have two ends and a passage therethrough for receiving said line,
(b) a stop element point located proximate said passage, the element extending between send ends and having a sleeve connecting same, said stop element being capable of being twisted to cause engagement of sleeve with the line;
(c) an anti-rotation element configured to engage said stop and slideable elements to prevent counter rotation of the stop element relative to said slideable element after making twisting engagement with the line;
so that, when said stop element is twisted to engage the line and prevented from untwisting by the anti rotation element, the slideable element is thereby prevented from sliding along the line until the anti-rotation element is disengaged.

2. The lock of claim 1 further including a slit in said slideable element extending at least a portion of the length of the element and from its outer surface to the passage.

3. The lock of claim 2 wherein said slit is of dimension smaller than the dimension of the stop element.

4. The lock of claim 2 wherein the slit is of dimension large enough to allow passage of a line therethrough.

5. The lock of claim 2 wherein said stop element is elastic and is stretchable to permit passage through said slit while distended.

6. The lock of claim 2 wherein said slit follows a non linear path along the outer surface.

7. The lock of claim 2 wherein the slit follows a serpentine path.

8. The lock of claim 2 wherein the slit follows a path with a jog.

9. The lock according to claim 1 wherein said stop element has a plurality of engagement ears.

10. The lock according to claim 1 wherein said sleeve has a non-circular cross section.

11. The lock according to claim 1 wherein said sleeve is elastomeric.

12. The lock of claim 1 wherein said anti-rotation element includes an engagement feature on said stop element and a like engagement feature associated with the slideable element, so that when said features are engaged with each other, the stop element is prevented from rotating.

13. A shock protector for a slideable for an element having ends and a passage therebetween and being slideable on a line having a fixed stop, comprising
a shock absorbing element extending from said ends and connected through said passage and having resilient portions which extend beyond said ends;
so that when said slideable element encounters said fixed stop, the contact is cushioned by said resilient portions.

14. The protector according to claim 13 wherein said shock absorbing element including a pair of ends and an elastomeric sleeve connecting said ends, said body having a passage to accommodate a line therethrough between the ends.

15. A method of releasably fixing the position of a slideable element having a passage therethrough, on a line comprising the steps of:
(a) elongating an elastomeric twistable sleeve;
(b) inserting the sleeve into the passage while elongated
(c) sliding the line through the sleeve within said slideable element;
(d) positioning the slideable element where desired along the line
(e) twisting the sleeve sufficiently to engage the line and prevent slippage.

16. The method of claim 15 further including the step presenting counter rotation of the sleeve to allow untwisting thereof, so that engagement of the line is maintained.
